(19) United States
(12) Patent Application Publication
(10) Pub. No.: US 2009/0080220 A1
(43) Pub. Date: Mar. 26, 2009

(54) Prism sheet and backlight module using the same

(75) Inventor: Shao-Han Chang, Tu-Cheng (TW)

Correspondence Address: PCE INDUSTRY, INC.;ATT. Steven Reiss, 458 E. LAMBERT ROAD, FULLERTON, CA, 92835, US

(73) Assignee: Hon Hai Precision Industry Co., LTD.

(21) Appl. No.: 11/998,718

(22) Filed: Nov. 30, 2007

Related U.S. Application Data
(63) Continuation of application No. 11/938,307, filed on Nov. 12, 2007.

(30) Foreign Application Priority Data
Sep. 21, 2007 (CN) 200710201800.X

(51) Int. Cl. F21V 5/02; F21V 7/04

(52) U.S. Cl. 362/620; 362/339

(57) ABSTRACT

An exemplary prism sheet includes a transparent main body. The transparent main body includes a surface and a plurality of micro-depressions integrally formed in the surface. Each of the micro-depressions has connecting sidewalls. A transverse width of each sidewall progressively decreases with increasing distance from the surface thereof. A backlight module using the present prism sheet is also provided.

### CROSS-REFERENCE TO RELATED APPLICATIONS

This application is related to a co-pending U.S. patent application, which is: application Ser. No. 11/938,307, and entitled “PRISM SHEET AND BACKLIGHT MODULE USING THE SAME”. In the co-pending application, the inventors are Tung-Ming Hsu and Shao-Han Chang. The co-pending application has the same assignee as the present application. The disclosure of the above identified application is incorporated herein by reference.

### BACKGROUND OF THE INVENTION

1. Field of the Invention

The present invention relates to a prism sheet for use in, for example, a backlight module, the backlight module typically being employed in a liquid crystal display (LCD).

2. Discussion of the Related Art

In a liquid crystal display device (LCD device), liquid crystal is a substance that does not itself illuminate light. Instead, the liquid crystal relies on light received from a light source, in order that the liquid crystal can provide displaying of information. In the case of a typical liquid crystal display device, a backlight module powered by electricity supplies the needed light.

FIG. 10 is an exploded, side cross-sectional view of a typical liquid crystal display device 100 employing a typical prism sheet 10. The liquid crystal display device 100 includes a housing 11 and a plurality of lamps 12 positioned in the housing 11. The liquid crystal display device 100 further includes a light diffusion plate 13, a prism sheet 10, and a LCD panel 15 stacked on the housing 11 in that order. The prism sheet 10 includes a base layer 101 and a prism layer 103 formed on the base layer 101. The prism layer 103 has a plurality of prism lenses 105 having a triangular cross section. The prism lenses 105 are arranged regularly, and each extends along a direction parallel to one edge of the prism sheet 10. In use, light emitted from the lamps 12 enters the prism sheet 10 after being scattered in the diffusion plate 13. The light is refracted and concentrated by the prism lenses 105 of the prism sheet 10, and then the light finally exits the prism lenses 105 and propagates into the liquid crystal display panel 15.

Generally, a method of manufacturing the prism sheet 10 includes the following steps: First, a melted ultraviolet-cured transparent resin is coated on the base layer 101, and then the melted ultraviolet-cured transparent resin is solidified to form the prism layer 103. The prism lenses 105 formed this way can be easily damaged or scratched due to their poor rigidity and mechanical strength of the prism layer 103.

In order to protect the prism layer 103 of the prism sheet 10, the liquid crystal display device 100 usually includes an upper light diffusion film 14 disposed on the prism sheet 10. Although the upper light diffusion film 14 and the prism sheet 10 are in contact with each other, a plurality of air pockets still exist at the boundary between the light diffusion film 14 and the prism sheet 10. When the liquid crystal display device 100 is in use, light passes through the air pockets, and some of the light undergoes total reflection at one or another of the corresponding boundaries. In addition, the upper light diffusion film 14 may absorb some of the light from the prism sheet 10. As a result, a brightness of light illumination of the liquid crystal display device 100 is reduced.

Therefore, a new prism sheet is desired in order to overcome the above-described shortcomings.

### SUMMARY

In one aspect, a prism sheet according to a preferred embodiment includes a transparent main body. The transparent main body includes a surface and a plurality of micro-depressions integrally formed in the surface. Each of the micro-depressions has connecting sidewalls. A transverse width of each sidewall progressively decreases with increasing distance from the surface thereof.

In another aspect, a backlight module according to a preferred embodiment includes a plurality of lamps, a light diffusion plate and a prism sheet. The light diffusion plate is disposed above the lamps and the prism sheet is stacked on the light diffusion plate. The prism sheet is same as described in a previous paragraph. The surface defining micro-depressions faces away from the light diffusion plate.

Other advantages and novel features will become more apparent from the following detailed description of various embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present prism sheet and backlight module. Moreover, in the drawings, like reference numerals designate corresponding parts throughout several views, and all the views are schematic.

FIG. 1 is a side, cross-sectional view of a backlight module using a prism sheet according to a first preferred embodiment of the present invention.

FIG. 2 is an isometric view of the prism sheet of FIG. 1.

FIG. 3 is a side, cross-sectional view of the prism sheet of FIG. 2, taken along line III-III thereof.

FIG. 4 is a side, cross-sectional view of the prism sheet of FIG. 2, taken along line IV-IV thereof.

FIG. 5 is an isometric view of a prism sheet according to a second preferred embodiment of the present invention.

FIG. 6 is a micrograph of the prism sheet of FIG. 5.

FIG. 7 is an abbreviated, isometric view of a prism sheet according to a fourth preferred embodiment of the present invention.

FIG. 8 is an abbreviated, isometric view of a prism sheet according to a fifth preferred embodiment of the present invention.

FIG. 9 is a side, cross-sectional view of a prism sheet according to a third preferred embodiment of the present invention.

FIG. 10 is side, cross-sectional view of a conventional backlight module using a typical prism sheet.

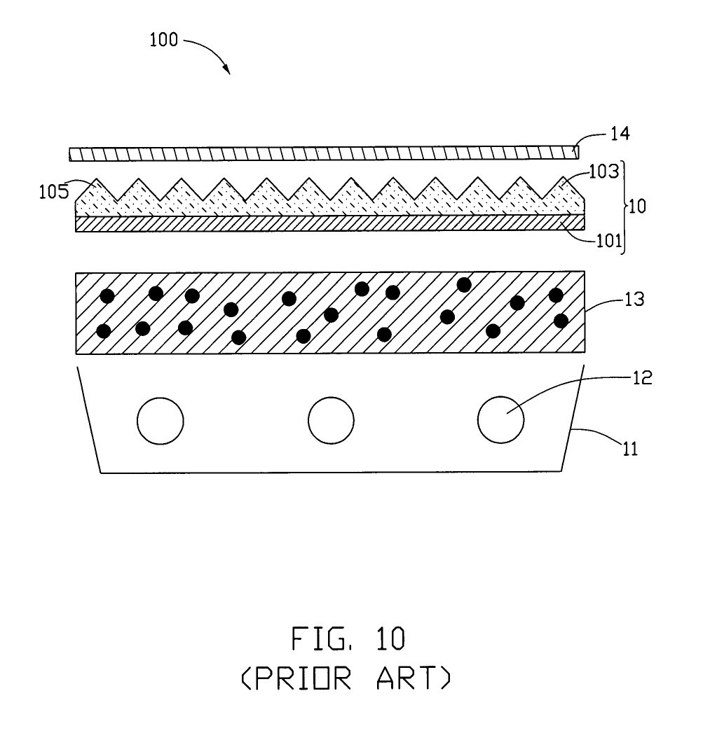

### DETAILED DESCRIPTION OF THE PREFERRED EMBODIMENTS

Reference will now be made to the drawings to describe preferred embodiments of the present prism sheet and backlight module, in detail.

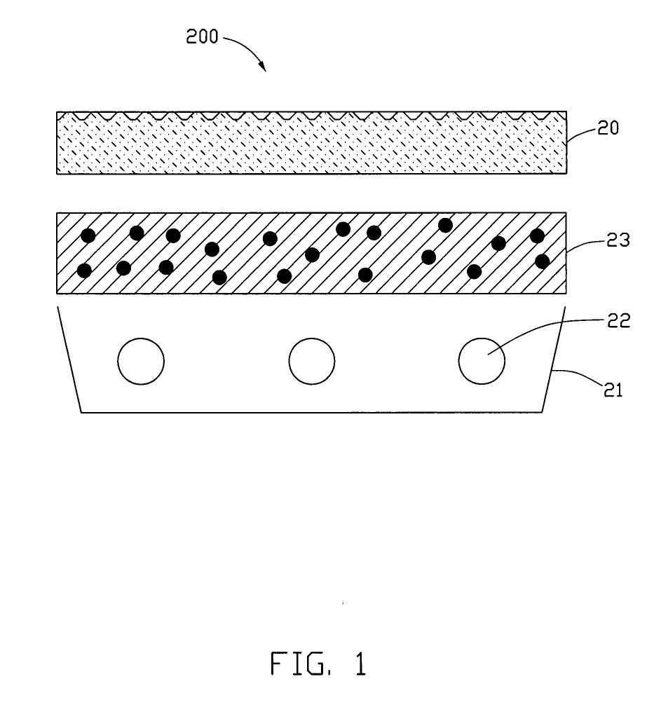

Referring to FIG. 1, a backlight module 200 in accordance with a first preferred embodiment of the present invention is shown. The backlight module 200 includes a prism sheet 20, a light diffusion plate 23, a plurality of lamps 22 and a housing 21. The lamps 22 are regularly aligned above a base of the housing 21. The light diffusion plate 23 and the prism sheet 20 are stacked on the top of the housing 21 in that order.

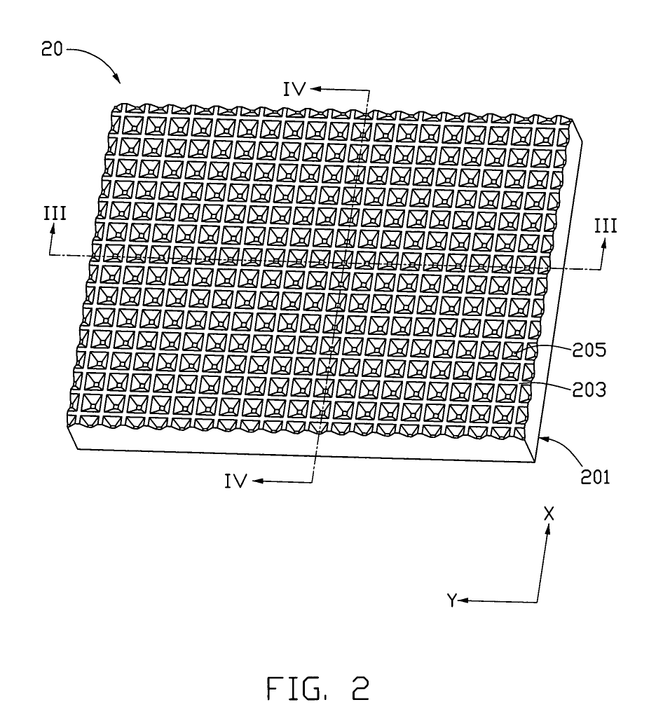

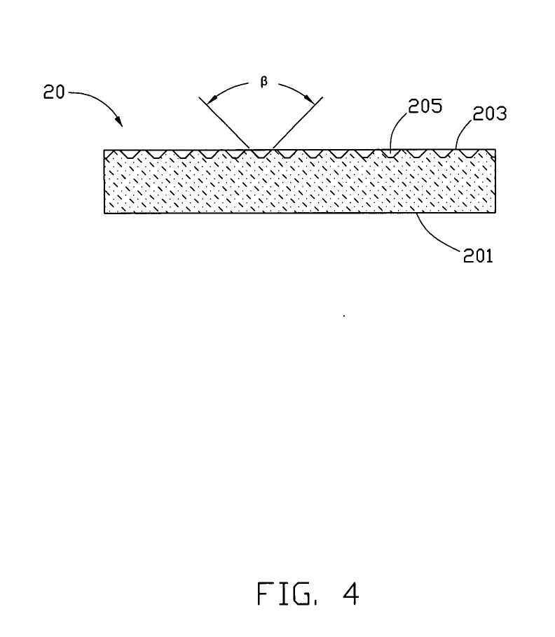

Referring to FIGS. 2 through 4, the prism sheet 20 includes a transparent main body. The transparent main body includes a light input surface 201, a light output surface 203, and a plurality of micro-depressions 205. The light output surface 203 and the light input surface 201 are on opposite sides of the main body. The prism sheet 20 defines the micro-depressions 205 in the light output surface 203 of the prism sheet 20. The prism sheet 20 is integrally formed by injection molding technology. Each micro-depression 205 has a shape like an inverted prism and forms four sidewalls connected with each other. A transverse width of each of the sidewalls progressively decreases with increasing distance from the light output surface 203. The prism sheet 20 is positioned on the light diffusion plate 23 such that the light input surface 201 is adjacent to the light diffusion plate 23 and the light output surface 203 faces away from the light diffusion plate 23.

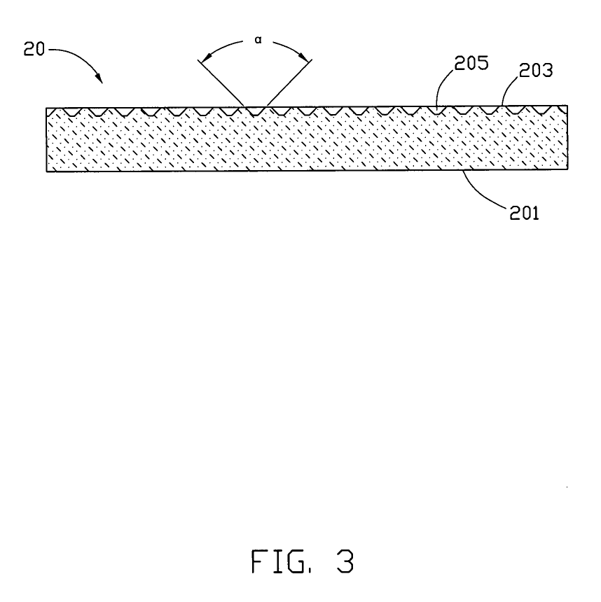

In the first embodiment, the micro-depressions 205 are formed in the light output surface 203 in a matrix manner. The rows and columns of the micro-depressions 205 in the matrix are parallel to the edges of the prism sheet 20 (along an X-axis or a Y-axis direction) correspondingly. Each micro-depression 205 is a square pyramidal groove forming four isosceles trapezium sidewalls. A pitch between centers of adjacent micro-depressions 205 along the X-axis direction or the Y-axis direction is configured to be in the range from about 0.025 millimeters to about 1 millimeter. Again referring to FIG. 3, dihedral angles α, β, defined by the sidewalls on opposite sides of each of the micro-depressions 205, are respectively configured to be in the range from about 60 degrees to about 120 degrees. The dihedral angle α equals to the dihedral angle β. In an alternative embodiment, the dihedral angle α can be configured to be different from the dihedral angle β. The dihedral angles α, β, could vary in accordance with the various requirements according to viewing angles from different directions. In another alternative embodiment, the rows or columns of the micro-depressions 205 may be oblique to the respective edges of the prism sheet 20 but have other alignments or orientations.

The light input surface 201 can be either a planar surface or a rough surface. The micro-depressions 205 of the light output surface 203 are configured for converging the received light emitted from the light input surface 201. A thickness of the prism sheet 20 is greater than that of a conventional prism sheet. The thickness of the prism sheet 20 is preferably in the range from about 0.4 millimeters to about 4 millimeters. The prism sheet 20 can be made of transparent material selected from the group consisting of polycarbonate (PC), polymethyl methacrylate (PMMA), polystyrene (PS), copolymer of methylmethacrylate and styrene (MS), and any suitable combination thereof.

Referring to FIG. 1 again, the lamps 22 can be point light sources such as light emitting diodes or linear light sources such as cold cathode fluorescent lamps. Even though the housing 21 is made of high reflectivity material, an extra coating can be further applied on the interior. In this embodiment, the lamps 22 are cold cathode fluorescent lamps. The housing 21 is made of high reflectivity metal.

Compared with the conventional prism sheet, the prism sheet 20 can be easily mass-produced via the injection molding method. Also, because the prism lenses of the conventional prism sheet is formed by solidifying the melted ultraviolet-cured transparent resin, in use, the prism lenses are easily damaged or scratched due to their poor rigidity and mechanical strength. Compared with the conventional prism sheet, the prism sheet 20 of the present invention has a better rigidity and mechanical strength. Therefore, the present prism sheet is not easy to be damaged or scratched when in use.

In addition, orientations of the inclined sidewalls of micro-depressions 205 could vary in accordance with the various requirements for viewing angles from different directions. In other words, the prism sheet 20 could have an orientation at an appropriate viewing angle between the X-direction and Y-direction directions (see FIG. 2). It could solve horizontal and vertical viewing angles problem associated with most conventional prism sheets.

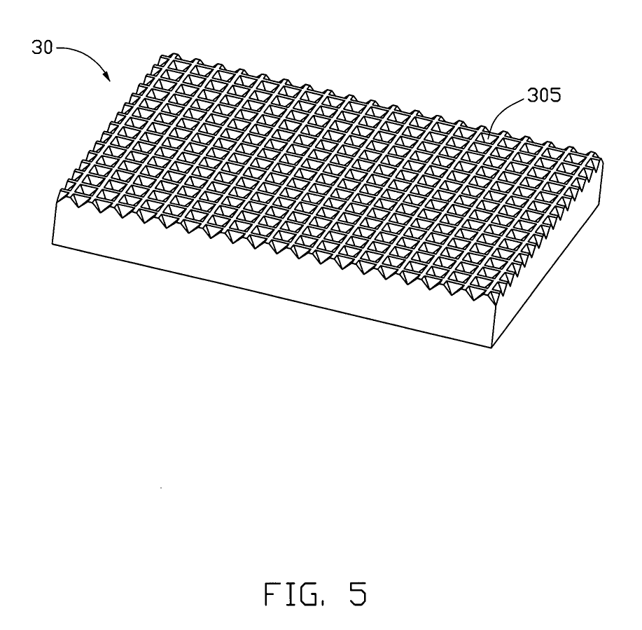

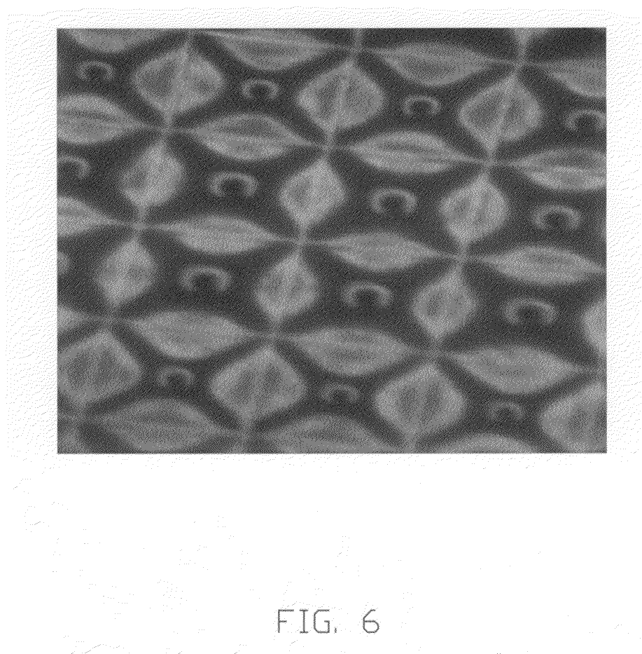

Referring to FIGS. 5 and 6, a prism sheet 30 in accordance with a second preferred embodiment of the present invention is shown. The prism sheet 30 is similar in principle to the prism sheet 20. However, each micro-depression 305 is a square pyramidal groove forming four isosceles triangular sidewalls.

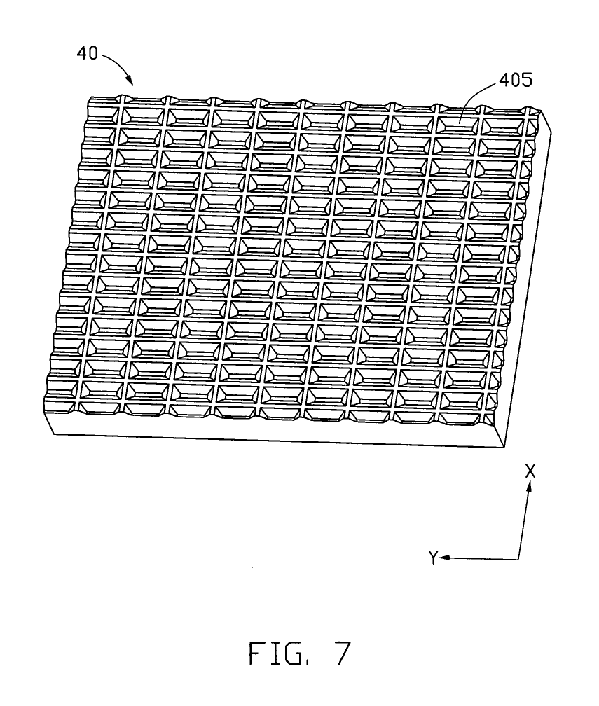

Referring to FIG. 7, an optical plate 40 according to a third embodiment is shown. The optical plate 40 is similar in principle to the optical plate 20, except that each of micro-depressions 405 is a polyhedron depression including four sidewalls. Each first sidewall on opposite sides of the polyhedron depression is an isosceles trapezium. A second pair of opposite sidewalls of the four sidewalls is larger isosceles trapeziums with planar surfaces parallel to a Y-direction.

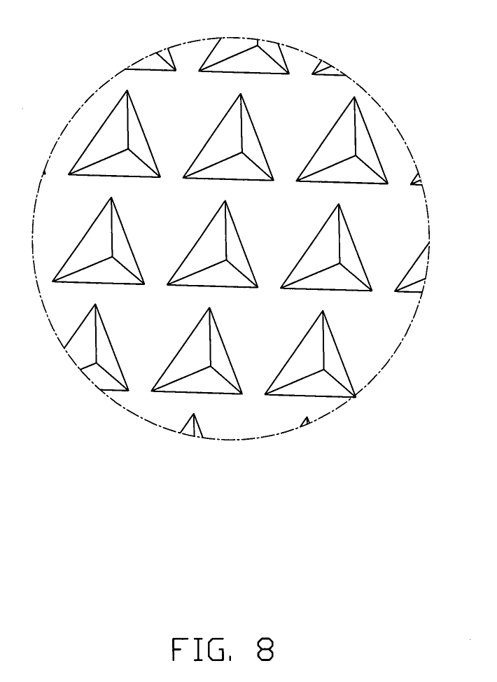

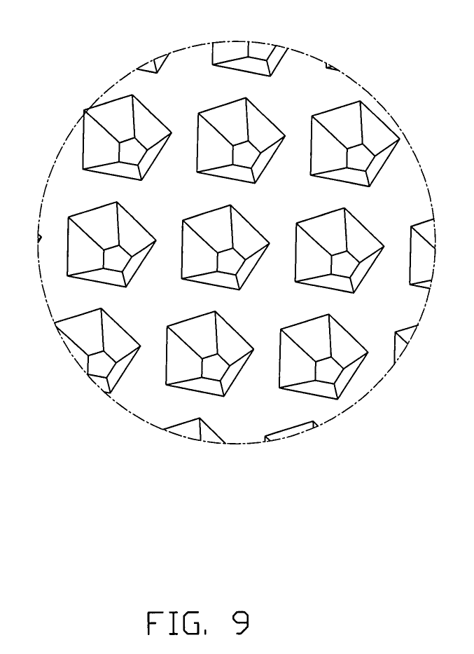

It should be noted that the scope of the present optical plate is not limited to the above-described embodiments. In particular, even though specific shapes of micro-depressions have been described and illustrated, the micro-depressions can have various other suitable shapes. For example, the micro-depressions can be four-sided (rectangular) pyramidal micro-depressions (referring to FIG. 7), three-sided (triangular) pyramidal micro-depressions (referring to FIG. 8), five-sided (pentagonal) pyramidal micro-depressions (referring to FIG. 9), and other multi-sided (polygonal) pyramidal micro-depressions, or frustums of these.

Finally, while various embodiments have been described and illustrated, the invention is not to be construed as being limited thereto. Various modifications can be made to the embodiments by those skilled in the art without departing from the true spirit and scope of the invention as defined by the appended claims.

What is claimed is:

1. A prism sheet comprising:
a transparent main body having
a surface, and
a plurality of micro-depressions integrally formed in the surface, wherein each of the micro-depressions has a plurality of connecting sidewalls, a transverse width of each sidewall progressively decreases with increasing distance from the surface thereof.

2. The prism sheet according to claim 1, wherein the micro-depressions are selected from a group consisting of three-sided pyramidal micro-depressions, four-sided pyramidal micro-depressions, five-sided pyramidal micro-depressions, other multi-sided pyramidal micro-depressions, and frustums of these.

3. The prism sheet according to claim 2, wherein the micro-depressions are four-sided pyramidal micro-depressions, and a dihedral angle defined by two opposite sidewalls of each of the four-sided pyramidal micro-depressions is in the range from about 60 degrees to about 120 degrees.

4. The prism sheet according to claim 1, wherein a pitch between centers of adjacent micro-depressions is in the range from about 0.025 millimeters to about 1 millimeter.

5. The prism sheet according to claim 1, wherein a thickness of the prism sheet is in the range from about 0.4 millimeters to about 4 millimeters.

6. The prism sheet according to claim 1, wherein the micro-depressions are formed in the surface in a matrix manner.

7. The prism sheet according to claim 6, wherein rows or columns of the micro-depressions are parallel to or slanted to the respective edges of the prism sheet.

8. The prism sheet according to claim 1, wherein the prism sheet is made of transparent material selected from the group consisting of polycarbonate, polymethyl methacrylate, polystyrene, copolymer of methylmethacrylate and styrene, and any combination thereof.

9. A backlight module comprising:
a plurality of lamps;
a light diffusion plate disposed above the lamps; and
a prism sheet disposed on the light diffusion plate, the prism sheet includes a transparent main body having
a surface facing away from the light diffusion plate, and
a plurality of micro-depressions integrally formed in the surface, wherein each of the micro-depressions has four connecting sidewalls, a transverse width of each sidewall progressively decreases with increasing distance from the surface thereof.

10. The backlight module according to claim 9, wherein the micro-depressions are selected from a group consisting of three-sided pyramidal micro-depressions, four-sided pyramidal micro-depressions, five-sided pyramidal micro-depressions, other multi-sided pyramidal micro-depressions, and frustums of these.

11. The backlight module according to claim 10, wherein the micro-depressions are four-sided pyramidal micro-depressions, and a dihedral angle defined by two opposite sidewalls of each of the four-sided pyramidal micro-depressions is in the range from about 60 degrees to about 120 degrees.

12. The backlight module according to claim 9, wherein a pitch between adjacent centers of the micro-depressions is in the range from about 0.025 millimeters to about 1 millimeter.

13. The backlight module according to claim 9, wherein a thickness of the prism sheet is in the range from about 0.4 millimeters to about 4 millimeters.

14. The backlight module according to claim 9, wherein the micro-depressions are formed in the surface in a matrix manner.

15. The backlight module according to claim 14, wherein rows or columns of the micro-depressions are parallel to or slanted to the respective edges of the prism sheet.

16. The backlight module according to claim 9, wherein the prism sheet is made of transparent material selected from the group consisting of polycarbonate, polymethyl methacrylate, polystyrene, copolymer of methylmethacrylate and styrene, and any combination thereof.
